(19) United States
(12) Patent Application Publication
(10) Pub. No.: US 2019/0111898 A1
(43) Pub. Date: Apr. 18, 2019

(54) AUTOMIBILE WINDOW REPAIR KIT AND METHOD

(71) Applicant: Jonathan Shephard, Missouri City, TX (US)

(72) Inventor: Jonathan Shephard, Missouri City, TX (US)

(21) Appl. No.: 15/955,321

(22) Filed: Apr. 17, 2018

Related U.S. Application Data
(60) Provisional application No. 62/486,077, filed on Apr. 17, 2017.

(51) Int. Cl. B60S 5/00

(52) U.S. Cl. CPC B60S 5/00

(57) ABSTRACT

The embodiments herein disclose a kit for emergency repair of broken window of automobiles. The kit comprises the a clear 20 gauge vinyl, a crystal clear gorilla tape, a double sided clear mounting strips, latex glove and dry erase pen. Following are the steps followed for repairing the broken window screen or wind shields of automobiles. The outer edge of window is wiped clean or dirt, grit and moisture before installation. The latex glove is worn. The double sided mounting tape is applied around the edge of the window being repaired. The gauge vinyl is placed across window area. The dry erase marker is used to outline the window and create line to cut the excess gauge vinyl. The excess gauge vinyl is trimmed, the crystal clear tape is applied to seal outer edge of gauge vinyl with the outer edge of the window.

### CROSS-REFERENCE TO RELATED APPLICATIONS

This application claims the priority of U.S. Provisional Patent Application No. 62/486,077, filed on Apr. 17, 2017, with the tile, “Kit”, and the content of which is incorporated in its entirety by reference herein.

### BACKGROUND

### Technical Field

The embodiments herein are generally related to a field of automobile service and repair. The embodiments herein are particularly related to a system and method for servicing and repairing automobiles. The embodiments herein are more particularly related to a repair kit for automobiles for fixing broken window screen and windscreen or wind shields of automobiles temporarily.

### Description of the Related Art

It is an extremely common occurrence that a windscreen of a motor car, lorry etc., gets broken during a course of a journey. The window or windscreen gets broken due to the stones thrown up by the wheels of other vehicles during a journey or due to a sudden temperature changes or due to undue stresses applied to the windscreen frame arising from twisting of the chassis over uneven road surfaces. When the windscreen made up of a safety glass is broken, the wind screen is shattered and a complete mosaic of tiny pieces of glass is formed thereby rendering the windscreen completely opaque. Therefore a driver has to punch or knock a hole in the shattered windscreen to enable him to drive further. As a result, the driver has a very restricted field of view or he is left without a windscreen thereby suffering with or facing a severe wind or getting trenched during a rain.

Generally people use “duct tape” for covering the broken/damaged window. But the duct tape leaves a residue when rubbed and removed. Further it sticks on the other portions of the window.

In some cases, “Trash bag” is also applied in the broken window. But the trash bag makes the window appear ugly. The trash bag has to be trimmed to fit with the broken window thereby rendering the fitting of the trash bag with the broken window very much difficult. The trash bag is not transparent and creates a blind spot. The trash bag also gets flapped while driving. Further the trash bag is not very much rigid.

“Painters plastic sheet”, which is also used for repairing the broken window, is not clear and not rigid. The painters' plastic sheet is too tough to apply and to be held at a particular spot. The painters' plastic sheet starts fluttering after exposure to wind. The painter's plastic sheet is also easily punctured.

An “AutoZone window” which is used in some cases for mending the broken window is too difficult to be installed. The AutoZone window is made of poor quality material.

Hence there is a need for a cheap, quick, efficient and effective method to repair or mend the broken window of automobiles easily. Also, there is a need for a repair kit for an emergency service of broken window screen or wind shields of automobiles.

The above-mentioned shortcomings, disadvantages and problems are addressed herein and which will be understood by reading and studying the following specification.

### OBJECTIVES OF THE EMBODIMENTS

The primary objective of the embodiment herein is to provide a kit for emergency servicing/repairing of broken window of automobiles.

Another object of the embodiment herein is to provide a kit for repairing broken window of automobiles, thereby providing an alternative for trash bags, plastic sheets, cardboard and cloth.

Yet another object of the embodiment herein is to provide an economical repair kit for servicing the broken window in comparison to the existing methods available for repairing the broken window of automobiles.

Yet another object of the embodiment herein is to provide a repair kit for mending or servicing the broken window of automobiles without requiring skilled personnel for operating the kit and repairing the broken window.

Yet another object of the embodiment herein is to provide a kit for repairing a broken window of automobiles without affecting/damaging an appearance of the automobile.

Yet another object of the embodiment herein is to provide a kit for repairing broken window of automobiles in an emergency situation.

These objects and the other advantages of the embodiments herein will become readily apparent from the following detailed description taken in conjunction with the accompanying drawings.

### SUMMARY

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

The following details present a simplified summary of the embodiments herein to provide a basic understanding of the several aspects of the embodiments herein. This summary is not an extensive overview of the embodiments herein. It is not intended to identify key/critical elements of the embodiments herein or to delineate the scope of the embodiments herein. Its sole purpose is to present the concepts of the embodiments herein in a simplified form as a prelude to the more detailed description that is presented later.

The embodiments herein provide a method and a kit for an emergency repair or servicing of broken window of automobiles. According to an embodiment herein, a repair or service kit is provided for repairing broken window of automobiles. The repairing kit is cheaper when compared to the existing methods for repairing the broken window of automobiles.

According to one embodiment herein, the kit for repairing broken window of automobiles is a temporary window repair kit which is used as an option to the currently available alternatives such as trash bags, plastic sheet, cardboard, cloth and the like.

According to one embodiment herein, the kit comprises a clear vinyl sheet of preset thickness and size, a crystal clear gorilla tape, a plurality of double sided clear mounting strips, latex glove, a scissor and dry erase pen. The scissor is used to cut the tape and make the size of components as per the requirement.

According to one embodiment herein, the kit comprises the 3 ft×54 in clear 20 gauge vinyl sheet, 12 ft. crystal clear gorilla tape, 10 double sided clear mounting strips, 1 latex glove and dry erase pen. The scissor is used to cut the tape and make the size of components as per the requirement.

According to one embodiment herein, a method for repairing the broken window screen or wind shields of automobiles with an emergency repair kit, is provided. The kit comprises a clear vinyl sheet of preset gauge and size, a crystal clear gorilla tape, a plurality of double sided clear mounting strips, latex glove, a scissor and dry erase pen. The scissor is used to cut the tape and make the size of components as per the requirement.

The outer edge of window to be repaired is wiped clean or dirt, grit and moisture before installation. The user applies a double sided mounting tape around the edges of the window being repaired. After applying the double sided mounting tape, the user places a vinyl sheet of preset gauge in a way that no wrinkles are present across window area. After placing the vinyl sheet in position, the dry erase marker is used to draw an outline around the window for forming a tear line for cutting the excess vinyl sheet. After trimming the excess vinyl sheet, the latex gloves are worn and crystal clear tape is applied to seal the outer edges of vinyl sheet with the outer edges of the window.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a flowchart explaining a method for emergency repairing the broken window of automobiles, according to one embodiment herein.

Although the specific features of the embodiments herein are shown in some drawings and not in others. This is done for convenience only as each feature may be combined with any or all of the other features in accordance with the embodiments herein.

### DETAILED DESCRIPTION OF THE EMBODIMENTS

In the following detailed description, a reference is made to the accompanying drawings that form a part hereof, and in which the specific embodiments that may be practiced is shown by way of illustration. The embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The embodiments herein provide a method and a kit for an emergency repair or servicing of broken window of automobiles. According to an embodiment herein, a repair or service kit is provided for repairing broken window of automobiles. The repairing kit is cheaper when compared to the existing methods for repairing the broken window of automobiles.

According to one embodiment herein, the kit for repairing broken window of automobiles is a temporary window repair kit which is used as an option to the currently available alternatives such as trash bags, plastic sheet, cardboard, cloth etc.

According to one embodiment herein, the kit comprises a clear vinyl sheet of preset thickness and size, a crystal clear gorilla tape, a plurality of double sided clear mounting strips, latex glove, a scissor and dry erase pen. The scissor is used to cut the tape and make the size of components as per the requirement.

According to one embodiment herein, the kit comprises the 3 ft×54 in clear 20 gauge vinyl sheet, 12 ft. crystal clear gorilla tape, 10 double sided clear mounting strips, 1 latex glove and dry erase pen. The scissor is used to cut the tape and make the size of components as per the requirement.

According to one embodiment herein, a method for repairing the broken window screen or wind shields of automobiles with an emergency repair kit, is provided. The kit comprises a clear vinyl sheet of preset gauge and size, a crystal clear gorilla tape, a plurality of double sided clear mounting strips, latex glove, a scissor and dry erase pen. The scissor is used to cut the tape and make the size of components as per the requirement.

The outer edge of window to be repaired is wiped clean or dirt, grit and moisture before installation. The user applies a double sided mounting tape around the edges of the window being repaired. After applying the double sided mounting tape, the user places a vinyl sheet of preset gauge in a way that no wrinkles are present across window area. After placing the vinyl sheet in position, the dry erase marker is used to draw an outline around the window for forming a tear line for cutting the excess vinyl sheet. After trimming the excess vinyl sheet, the latex gloves are worn and crystal clear tape is applied to seal the outer edges of vinyl sheet with the outer edges of the window.

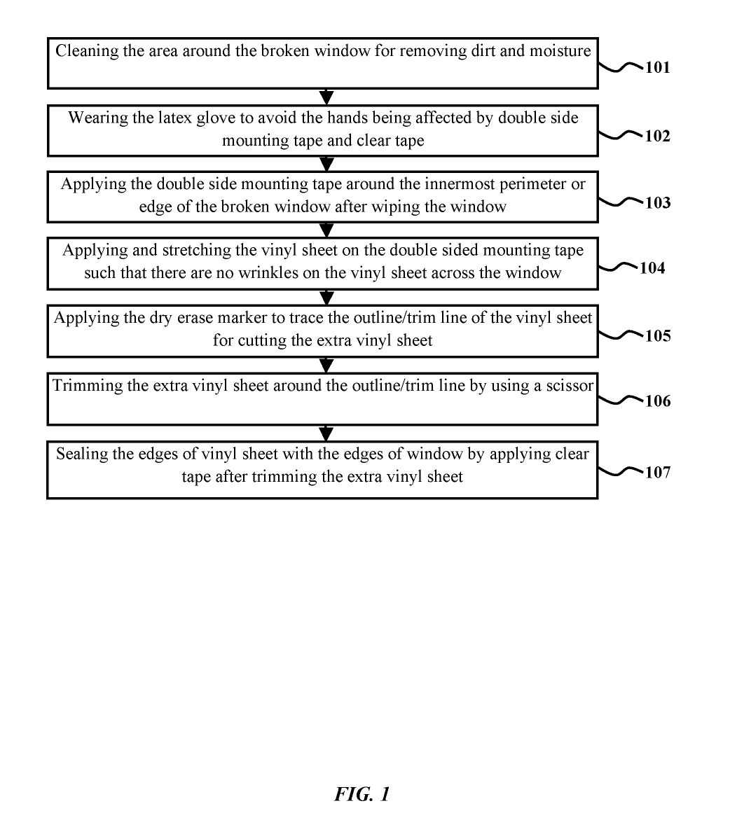

FIG. 1 illustrates a flowchart explaining a method for emergency repairing the broken window of automobiles, according to one embodiment herein. The area around a broken window is cleaned with a cloth or spray for removing the dirt and moisture (101). The latex glove is worn to avoid the hands being affected by double side mounting tape and clear tape (102). A double sided mounting tape is applied/adhered around the innermost perimeter or edge of the broken window screen or wind shields after wiping the window (103). The vinyl sheet is applied and stretched on the double sided mounting tape such that there are no wrinkles on the vinyl sheet across the window (104). A dry erase marker is used to trace the outline/trim line of the vinyl sheet for cutting the extra vinyl sheet (105). The extra vinyl sheet around the outline/trim line is trimmed by using a scissor (106). The edges of vinyl sheet are sealed with the edges of window by applying clear tape after trimming the extra vinyl sheet (107).

It is to be understood that the phraseology or terminology employed herein is for description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

It is also to be understood that the following claims are intended to cover all of the generic and specific features of the embodiments described herein and all the statements of the scope of the embodiments which as a matter of language might be said to fall there between.

What is claimed is:

1. A method for repairing broken window of automobiles with a repairing kit, the method comprises the steps of:
applying/fixing a double sided mounting tape around an innermost perimeter or edge of a broken window after wiping and cleaning an area around the broken window for removing dirt/dust and moisture;
fixing a vinyl sheet on the double sided mounting tape such that there are no wrinkles on the vinyl sheet across the window screen or wind shields, and wherein the vinyl sheet is stretched to avoid wrinkles;
drawing an outline/trim line of the vinyl sheet with an dry erase marker to trace the window area for cutting an extra/excess vinyl sheet;
trimming the extra/excess vinyl sheet around the outline/trim line by using a scissor; and
sealing a plurality of edges of vinyl sheet with the edges of window by applying crystal clear gorilla tape after trimming the extra/excess vinyl sheet;
wherein the repairing kit comprises the double sided mounting tapes/strips, the vinyl sheet, the dry eraser marker pen, the latex glove, the scissor and the crystal clear gorilla tape.

2. The method according to claim 1, wherein the vinyl sheet is of pre-set gauge (thickness) and size.

3. The method according to claim 1, wherein the repairing kit comprises a plurality of double sided mounting tapes/strips.

4. A repairing kit for repairing broken window of automobiles, the kit comprises:
a double sided mounting tape/strip;
a vinyl sheet,
a dry eraser marker pen;
a latex glove; and
a crystal clear gorilla tape.

5. The repairing kit according to claim 4, wherein the vinyl sheet of a pre-set gauge and size.

6. The repairing kit according to claim 4, further comprises a plurality of double sided mounting tape.
